(19) United States
(12) Patent Application Publication
(10) Pub. No.: US 2015/0000504 A1
(43) Pub. Date: Jan. 1, 2015

(54) MUSICAL INSTRUMENT KEYBOARD INCLUDING KEY ACTION USING MAGNETS

(71) Applicant: Jory Bell, San Francisco, CA (US)

(72) Inventor: Jory Bell, San Francisco, CA (US)

(73) Assignee: MISELU INC, San Francisco, CA (US)

(21) Appl. No.: 14/321,693

(22) Filed: Jul. 1, 2014

Related U.S. Application Data
(60) Provisional application No. 61/841,783, filed on Jul. 1, 2013.

(51) Int. Cl. G10C 3/12

(52) U.S. Cl. CPC G10C 3/12
USPC 84/440

(57) ABSTRACT

Embodiments generally relate to music devices. In one embodiment, an apparatus includes a musical instrument keyboard including a keyboard body and a key. The key is operable by a user to cause movement of the key. The apparatus also includes one or more magnets positioned to affect the movement of the key.

### CROSS REFERENCES TO RELATED APPLICATIONS

This application claims priority from U.S. Provisional Patent Application No. 61/841,783, entitled “Musical Instrument Keyboard Including Key Action Using Magnets,” filed Jul. 1, 2013, which is hereby incorporated by reference as if set forth in full in this application for all purposes.

This application is related to U.S. patent application Ser. No. 13/748,421, entitled “Collapsible Musical Keyboard,” filed Jan. 23, 2013, which is hereby incorporated by reference as if set forth in full in this application for all purposes.

### BACKGROUND

Various musical instruments provide a keyboard of several or many individual keys that are used to play notes on the instrument. Musical instrument keyboards include those found on a standard piano, electric piano, synthesizer, sequencer, controller or other types of instruments. These instruments can use mechanical movements, or analog or digital electronics to produce sounds.

### SUMMARY

Embodiments generally relate to music devices. In one embodiment, an apparatus includes a musical instrument keyboard including a keyboard body and a key. The key is operable to cause movement of the key by a user. The apparatus also includes one or more magnets positioned to affect the movement of the key.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows an example of a musical instrument keyboard, according to some implementations.

FIG. 2 illustrates an example of a key assembly, according to some implementations.

FIG. 3 shows the key assembly of FIG. 2 with the key in a resting state, according to some implementations.

FIG. 4 shows the key assembly of FIG. 3 with the key in a resting state, where a gap between the two magnets has been adjusted, according to some implementations.

FIG. 5 shows a perspective view of the key assembly of FIG. 2, according to some implementations.

FIG. 6 shows the perspective view of FIG. 5 with the key in its resting position, according to some implementations.

FIG. 7 shows the key assembly of FIG. 2 with the key in a collapsed state, according to some implementations.

### DETAILED DESCRIPTION

Embodiments generally relate to music devices. In various embodiments, an apparatus includes a musical instrument keyboard including a keyboard body and keys. The keys are operable to cause movement of the keys by a user. The apparatus also includes one or more magnets positioned to affect the movement of the keys. Specifically, the magnets affect the keys' action in the musical instrument keyboard.

Often, the minimum requirements for a desirable keyboard action (e.g., movement and/or user feel of a key as it is pressed) include the feel of the initial “touch” or push on a key, combined with the perceived “weight,” or continued press of the key, and also the feel upon “release” of the key. In various embodiments described herein, one or more of these action components are affected by a force from one or more magnetic fields. Other embodiments may use magnetic fields to affect any other action components or other movement of a key, in general.

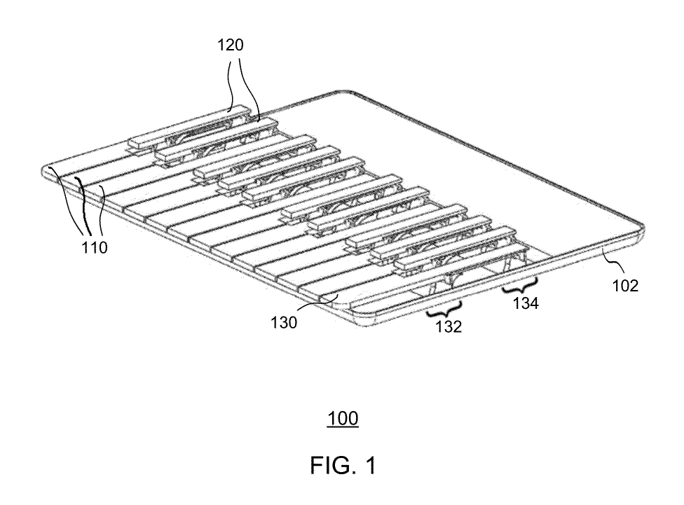

FIG. 1 shows an example of a musical instrument keyboard 100, according to some implementations. This type of small-scale, folding keyboard is described in detail in the U.S. patent application referenced above. It should be apparent that aspects of the embodiments described herein may be used with any other suitable type of musical instrument keyboard. For example, keyboards with any number, size, and shape of keys may be used. The keys can be fixed in place or movable. They keyboard may be fixed or capable of being folded or otherwise modified in its size and shape. In general, many different keyboards and key types can be adapted for use with features of the embodiments disclosed herein.

As shown in FIG. 1, musical instrument keyboard 100 includes a body 102 and keys 110 and 120. As shown, keys 110 are so-called “white” keys, and keys 120 are so-called “black” keys. Other keyboards that may be suitable with features of embodiments of the invention can have different key arrangements.

In various implementations, the keys 110 and 120 are operable by a human user, where, for example, each the key is operable to cause movement of the key by the user. As described in more detail below, one or more magnets are positioned to affect the movement of each key.

As an example, a key 130 includes action mechanisms at 132 and 134 that effect the action of key 130. These mechanisms may include mechanical, electronic, electromechanical, magnetic, or other movements or forces. In general, the action mechanisms can vary in their placement and workings. Any number of action mechanisms can be used. These mechanisms are described in more detail below.

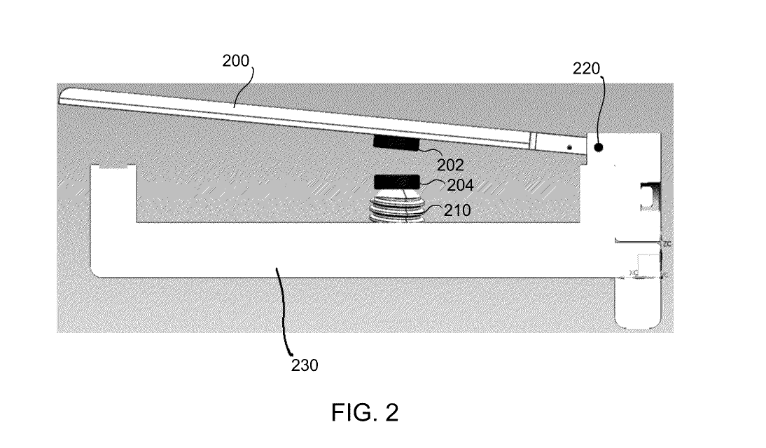

FIG. 2 illustrates an example of a key assembly, according to some implementations. In this particular embodiment, a pair of magnets 202 and 204 is used to affect a simplified action mechanism. Key 200 includes upper magnet 202. In some implementations, upper magnet 202 is coupled to the surface of key 200. In some implementations, key 200 is provided with a pivot point 220. Pivot point 220 is attached to keyboard frame 230 or keyboard body 230. In some implementations, lower magnet 204 is coupled to the surface of keyboard body 230.

In some implementations, the key assembly may include a mechanism used for re-positioning magnet 204. In some implementations, the mechanism may be implemented with a screw 210. In some implementations, keyboard body 230 may include a screw receptacle (not shown) for receiving screw 210, where the screw receptacle receives screw 210 such that the screw can be positioned at different positions inward or outward in the receptacle to move an affixed magnet. For example, in some implementations, lower magnet 204 may be affixed or attached to screw 210.

Screw 210 can be manually rotated to extend up or down, which moves lower magnet 204 up or down. This movement adjusts the distance between upper magnet 202 and lower magnet 204. As described in more detail below, the affixed magnet's movement changes an affect of a magnetic field on a movement of key 200.

For ease of illustration, some implementations are described in the context of one key. These implementations and others may apply to multiple keys, each being affected by multiple corresponding magnets (e.g., upper magnets and lower magnets). Similarly, while some implementations are described in the context of one screw receptacle in keyboard body 230, these implementations and others may be applied to multiple screw receptacles in the keyboard body (e.g., one or more screw receptacles and corresponding screws per key). Various implementations are described herein in the context one screw per key. In various implementations, there may be a single adjustable bar for all keys, where the bar supports all lower magnets for the keys.

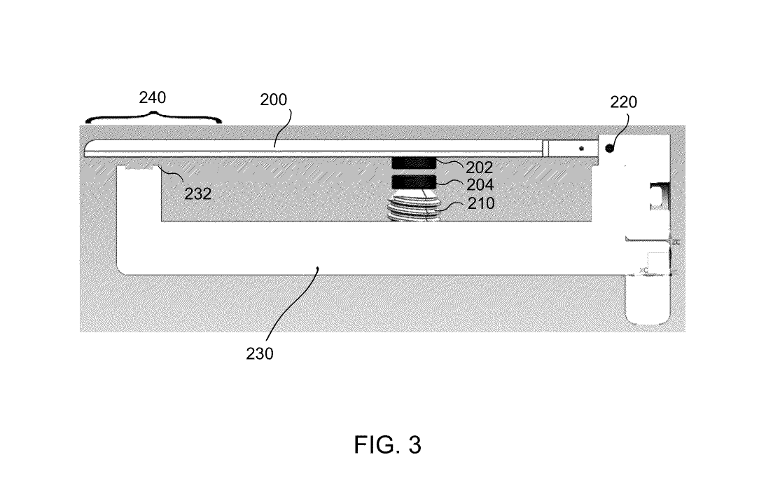

FIG. 3 shows the key assembly of FIG. 2 with the key in a resting state, according to some implementations. In the resting state no force is being applied to the top of key 200. In other words, key 200 is not being pressed down or played by a human user's digit (e.g., thumb or finger). In various implementations, in the resting state as shown, the surface of keys 200 is parallel to the base of keyboard body 230. When the user pushes downward on key 200, key 200 moves downward pivoting at pivot point 220.

In some implementations, magnets 202 and 204 are bar magnets in the shape of small discs. In some implementations, magnets 202 and 204 may have the same size. In some implementations, magnets 202 and 204 may have different sizes.

As is known in the art, each bar magnet has two ends. One end, or pole, is designated as “north” or “N” while the other end is designated as “south” or “S”. These designations indicate the direction of magnetic vector. In some implementations, a pole of magnet 202 is in proximity to a pole of magnet 204. In some implementations, magnets 202 and 204 create a repelling magnetic force. Accordingly, when a user pushes downward on key 200, key 200 moves downward but with resistance caused by the repelling magnetic force.

In a particular embodiment, the two magnets are positioned so as to repel each other. That is, the same poles (two N poles, or two S poles) are positioned nearest or facing each other so that magnetic repelling occurs.

As such, as indicated above, the affixed magnet's movement changes an affect of a magnetic field on a movement of key 200. The magnetic force acts to push at least a portion of key 200 away from at least a portion of keyboard body 230.

As shown in FIG. 3, the gap between the two magnets has been adjusted with screw 210 so that key 200 is horizontal and parallel to keyboard body 230. In this embodiment the keyboard could be on a flat surface that is normal to the direction of gravity. In various implementations, the strength of the repelling force of the magnets is sufficient to hold the key above the edge stop 232 of keyboard body 230.

When the key is pressed, such as by applying a force in the area of 240 to the key by a user's finger, the user feels resistance caused by the magnetic force created by magnets 202 and 204. The key pivots about pivot point 220. Downward movement of the key, or rotation about the pivot point, can be sensed by any suitable means such as by using a mechanical switch, distance or ranging of the key, image detection, motion detection, etc.

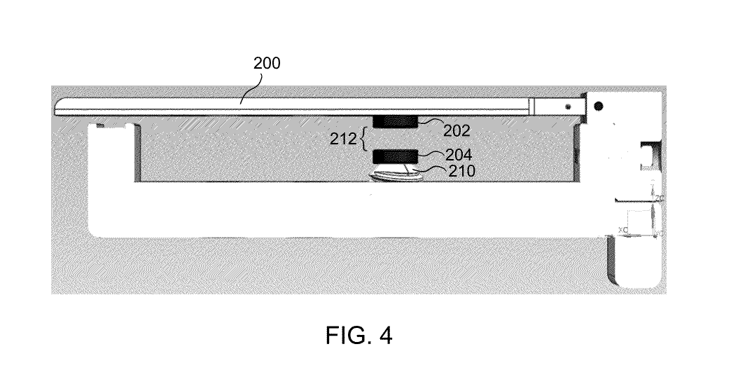

FIG. 4 shows the key assembly of FIG. 3 with the key in a resting state, where a gap 212 between the two magnets 202 and 204 has been adjusted, according to some implementations. Comparing FIGS. 3 and 4, by adjusting screw 210 upward or downward, gap 212 between upper magnet 202 and lower magnet 204 can be made smaller (FIG. 3) or larger (FIG. 4). As such, the repelling force on the key can be regulated or set at a time of manufacture, time of operation, or in other situations.

In various implementations, the repelling force increases exponentially as gap 212 decreases. For example, the repelling force on the key 200 is larger when gap 212 is smaller (FIG. 3), whereas the repelling force on key 200 is smaller when gap 212 is larger (FIG. 4). In some implementations, gap 212 does not reach zero and is large enough such that the repelling force is perceived by the user to be substantially linear. In some implementations, gap 212 does not reach zero and stays small enough such that the repelling force is perceived by the user to be substantially nonlinear or spongy. As such, different heights/gap sizes for the adjustable lower magnet provide different key “feel” (e.g., spring constant, linearity, etc.) for each lower magnet position.

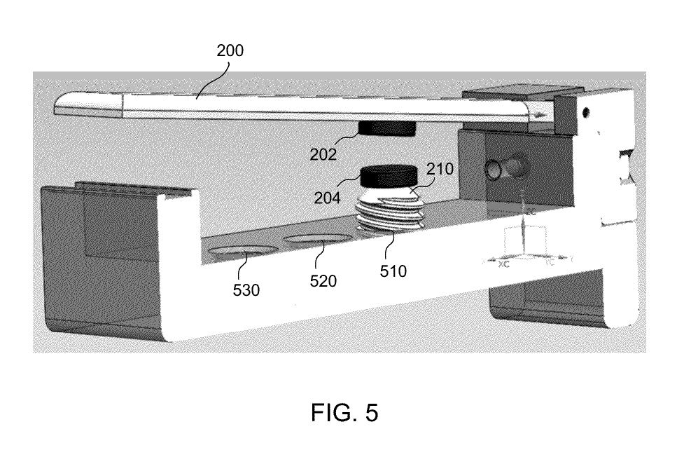

FIG. 5 shows a perspective view of the key assembly of FIG. 2, according to some implementations. As shown, a screw receptacle 510 receives and holds screw 210. In some implementations, the key assembly may include additional screw receptacles 520 and 530.

In various implementations, these additional receptacles enable the lower magnet 204 to be placed in different positions to achieve different types of action mechanisms. In some implementations, provision can be made for upper magnet 202 to be moved directly above the other receptacles so that during operation upper magnet 202 and lower magnet 204 will be substantially aligned. For example, upper magnet 202 can be removably affixed with adhesive, or retained by mechanical means as with a set screw (not shown), friction fitting into a close-fitting hole, (not shown), etc.

In various implementations, as lower magnet 204, upper magnet 202, and screw 210 are repositioned from receptacle 510 to receptacle 520, the gap increases slightly and the repelling force decreases slightly. This makes key 200 easier to push down, giving the key press a different feel.

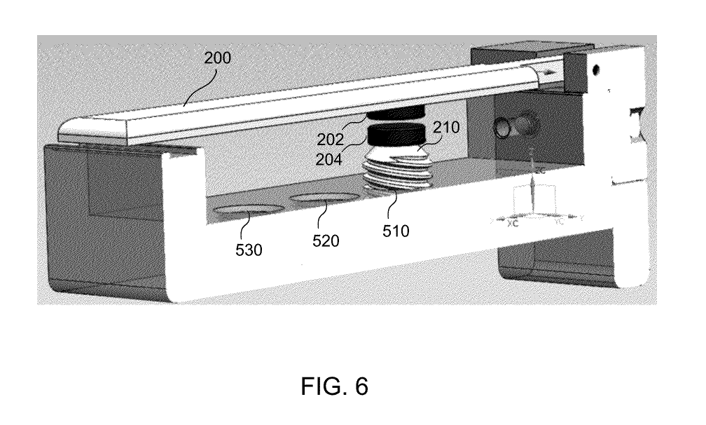

FIG. 6 shows the perspective view of FIG. 5 with the key in its resting position, according to some implementations. As shown, the assembly includes key 200, upper magnet 202, lower magnet 204, receptacle 510 that receives and holds screw 210, receptacle 520, and receptacle 530.

Although the description has been described with respect to particular embodiments thereof, these particular embodiments are merely illustrative, and not restrictive. For example, the magnets can be arranged so that they attract rather than repel. This can be achieved by placing opposing poles of the pair of magnets in proximity to each other. In the examples above, one of the magnets can be turned around to make the magnets attract each other. In such an application, the magnets may be moved to the opposite end of the pivot point in order that the magnetic attraction can be used to provide resistance to a user's downward pressure on a key.

In some implementations, a combination of magnets may be used such that one or more magnets provide a repelling force in order to control the feel of the key presses when the keys are in an open position. In some implementations, one or more magnets provide an attracting force in order to cause the keys to stay collapsed and not rattle around in the closed position when the keys are in a collapsed/closed position as shown below.

In various implementations, a combination of magnets that provide a repelling magnetic force are different from a combination of magnets that provide an attracting magnetic force. For example, referring again to FIG. 2 through FIG. 4, when in an open position, upper magnet 202 aligns with lower magnet 204, thereby creating a repelling magnetic force.

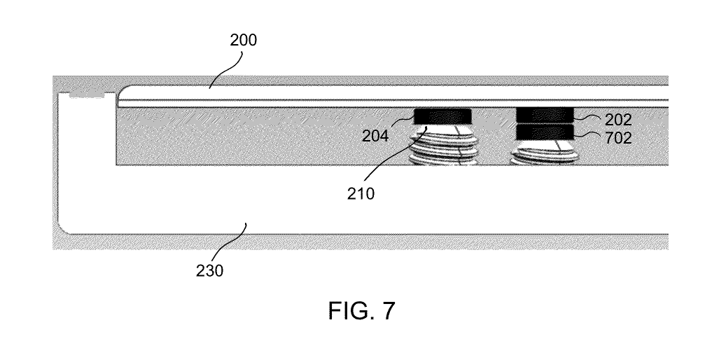

FIG. 7 shows the key assembly of FIG. 2 with the key in a collapsed state, according to some implementations. As shown, when in a collapsed/closed position, upper magnet 202 may align with a different lower magnet 702.

In various implementations, lower magnet 702 has an opposite polarity from lower magnet 204, where the top surface of lower magnet 702 and the bottom surface of upper magnet 202 have opposite poles (e.g., N pole and S pole). Because surfaces having opposite poles are positioned nearest or facing each other, magnetic attraction occurs. In other words, upper magnet 202 and lower magnet 702 create an attracting magnetic force.

Different shapes, types and numbers of magnets may be used. The magnet faces need not be parallel. Different shapes of the magnetic surfaces can be used. In a particular embodiment, only one magnet need be used, and the opposite material may be a metal that is susceptible to attraction from a magnetic field. Electromagnetic devices may be used. Magnets can be formed with, or use, microelectromechanical systems (MEMS) technology. Other materials and processes may be used that provide a magnetic force to effect all or a portion of a key's action.

Implementations described herein provide number benefits. Implementations described herein replicate aspects of the traditional feel of the keys in a musical keyboard that is extremely compact, low cost, light and with different and fewer moving parts than the traditional keyboards. Such implementations apply to a musical keyboard that is made to collapse, fold, or otherwise change shape for purposes such as to save space, mate to a different device, etc. Implementations replicate aspects of the traditional “touch” and feel of playing the keyboard that is important to the ability of a musician to play the instrument well.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. An apparatus comprising:
a musical instrument keyboard including a keyboard body and a key, wherein the key is operable by a user to cause movement of the key; and
one or more magnets positioned to affect the movement of the key.

2. The apparatus of claim 1, further comprising:
a first magnet on a surface of the key; and
a second magnet on a surface of a keyboard body, wherein the key is coupled to the keyboard body.

3. The apparatus of claim 1, further comprising:
a pole of a first magnet in proximity to a pole of a second magnet.

4. The apparatus of claim 1, wherein a first magnet and a second magnet create a repelling magnetic force.

5. The apparatus of claim 1, wherein a first magnet and a second magnet create a repelling magnetic force, and wherein the magnetic force acts to push at least a portion of the key away from at least a portion of the keyboard body.

6. The apparatus of claim 1, further comprising a mechanism for re-positioning at least one magnet.

7. The apparatus of claim 1, further comprising:
a magnet affixed to a screw; and
a screw receptacle in the keyboard body for receiving the screw so that the screw can be positioned at different positions inward or outward in the receptacle to move the affixed magnet.

8. The apparatus of claim 1, further comprising
a magnet affixed to a screw; and
a screw receptacle in the keyboard body for receiving the screw so that the screw can be positioned at different positions inward or outward in the receptacle to move the affixed magnet, wherein the affixed magnet's movement changes an affect of a magnetic field on a movement of the key.

9. The apparatus of claim 1, further comprising multiple screw receptacles in the keyboard body.

10. The apparatus of claim 1, wherein a first magnet and a second magnet create an attracting magnetic force.

11. An apparatus comprising:
a musical instrument keyboard including a keyboard body and a plurality of keys, wherein each key is operable by a user to cause movement of the key, and wherein the keys are arranged as black and white keys in a traditional piano keyboard arrangement; and
one or more magnets positioned to affect the movement of at least one of the keys.

12. The apparatus of claim 11, further comprising:
a first magnet on a surface of the at least one key; and
a second magnet on a surface of a keyboard body, wherein the at least one key is coupled to the keyboard body.

13. The apparatus of claim 11, further comprising:
a pole of a first magnet in proximity to a pole of a second magnet.

14. The apparatus of claim 11, wherein a first magnet and a second magnet create a repelling magnetic force.

15. The apparatus of claim 11, wherein a first magnet and a second magnet create a repelling magnetic force, and wherein the magnetic force acts to push at least a portion of the at least one key away from at least a portion of the keyboard body.

16. The apparatus of claim 11, further comprising a mechanism for re-positioning at least one magnet.

17. The apparatus of claim 11, further comprising:
a magnet affixed to a screw; and
a screw receptacle in the keyboard body for receiving the screw so that the screw can be positioned at different positions inward or outward in the receptacle to move the affixed magnet.

18. The apparatus of claim 11, further comprising
a magnet affixed to a screw; and
a screw receptacle in the keyboard body for receiving the screw so that the screw can be positioned at different positions inward or outward in the receptacle to move the affixed magnet, wherein the affixed magnet's movement changes an affect of a magnetic field on a movement of the at least one key.

19. The apparatus of claim 11, further comprising multiple screw receptacles in the keyboard body.

20. A method comprising:
providing a musical instrument keyboard including a keyboard body and a key, wherein the key is operable by a user to cause movement of the key; and
providing one or more magnets positioned to affect the movement of the key.
